(19) United States
(12) Patent Application Publication
(10) Pub. No.: US 2024/0423431 A1
(43) Pub. Date: Dec. 26, 2024

(54) DEDUSTER

(71) Applicant: Bruce W. Beckmann, Madison, CT (US)

(72) Inventor: Bruce W. Beckmann, Madison, CT (US)

(21) Appl. No.: 18/692,635

(22) PCT Filed: Sep. 16, 2022
(86) PCT No.: PCT/US2022/043792

§ 371 Date: Mar. 15, 2024

Related U.S. Application Data
(60) Provisional application No. 63/245,743, filed on Sep. 17, 2021.

(51) Int. Cl. A47L 9/16

(52) U.S. Cl. CPC A47L 9/1683; A47L 9/1608; A47L 9/165; A47L 9/1666

(57) ABSTRACT

A deduster collects pellets by way of a vacuum source and separates dust associated through cyclonic movement. The dust separates from the pellets through the cyclonic movement. thereby shaking the dust from the pellets and through a sieve. The dust is retained in a storage volume and ultimately transported to a storage drum. The pellets are retained by the sieve body in an interior volume therein. The pellets. due to cyclonic movement. are transmitted through the sieve body and out of the deduster to a receptacle. Optionally. the pellets are moved to a receptacle by way of the addition of vacuum and/or due to gravity.

### CROSS-REFERENCE TO RELATED APPLICATIONS

This application claims priority to U.S. Patent Application Ser. No. 63/245,743,filed Sep. 17, 2021, the contents of which is incorporated in its entirety herein.

### BACKGROUND OF THE PRESENT DISCLOSURE

### A. Field of Endeavor

The present disclosure relates to dedusting apparatuses, wherein such dedusting apparatuses are utilized to separate dust and other material below a certain size from pellets or grain that equals and/or is greater than a certain size.

### B. Background Information

Dedusting systems are heavily utilized for commercial separation of dust and fine material not intended for commercial use from pellets or grain that are intended for commercial use. Such dust and fine material can cause poor performance of the equipment and can create a poor commercial product. Dedusting systems are common for commercial plastics and molding operations and agriculture feed. Current dedusting systems require vacuum pressure to transfer the pellets through the deduster as well as additional power or air sources to blow-off dust and fine material from the pellets or grain. For instance, some such systems use compressed air to blow dust upward while the pellets flow laterally or downward. Other dedusting systems utilize static electricity to attract dust and remove it from pellets or grain. Other dedusting systems utilize a tumbler to separate the pellets or grain from dust. Other such systems use a series of shaker trays that, by way of force such as gravity and/or a vacuum pressure, shake the dust and fine material from the pellets or grain. All of the aforementioned systems are costly in that they require additional energy to operate, thereby lending themselves to additional modes of failure. Additionally, such systems are not inline and can be cumbersome or bulky, thus requiring extra complexities to add the filtration system into a manufacturing system. Furthermore, such systems have a negative impact on the environment given they require multiple sources of energy.

### SUMMARY OF THE PRESENT DISCLOSURE

A deduster system includes a deduster having a body that includes an upper end and a lower end, the upper end having a top surface and the lower end having a bottom surface, and a side surface joining the top surface and bottom surface. The upper end has an inlet port and the lower end having an outlet port. The deduster has a central vertical axis, a horizontal axis, and a depthwise axis.

The deduster includes a sieve configured to surround the inlet port and the outlet port. The sieve has an upper inlet end including a portion where the ingress port is. The sieve has a lower outlet end including a portion where the outlet portion is. The ingress port on the sieve is co-located with the inlet port on the exterior body. The egress port on the sieve is co-located with the outlet port on the exterior body.

The inlet port and the outlet port are angled with respect to each other such that there is a bend or an offset therebetween. In one embodiment, the inlet port is generally orthogonal to the outlet port. In some embodiments, the inlet port is on the upper end of the exterior body such that it is on the top surface or the side surface. In some embodiments, the outlet port is on the lower end of the exterior body such that it is on the bottom surface or the side surface. Optionally, the inlet port is on the top surface and the outlet port is on the side surface. Optionally, the inlet port is on the side surface and the outlet port is on the bottom surface. Optionally, the inlet port is on a first portion of the side surface and the outlet port is on a second portion of the side surface. Optionally, there is a bend, angle or offset between the inlet port and the outlet port. Optionally, there is a bend, angle or offset in the inlet port and/or in the outlet port.

The ingress port and the egress port are, optionally, angled with respect to each other such that there is a bend or an offset therebetween. In one embodiment, the ingress port is generally orthogonal to the egress port. In some embodiments, the ingress port is on the upper inlet end of the sieve such that it is on the top surface or the side surface. In some embodiments, the egress port is on the lower outlet end of the sieve such that it is on the bottom surface or the side surface. Optionally, the ingress port is on the top surface and the egress port is on the side surface. Optionally, the ingress port is on the side surface and the egress port is on the bottom surface. Optionally, the ingress port is on a first portion of the side surface and the egress port is on a second portion of the side surface.

The deduster has an interior volume defined by the sieve such that pellets (or grain) are introduced into the interior volume (by way of blowing compressed air, vacuum and/or gravity) causing cyclonic movement thereby separating dust and fine material from the pellets (or grain) through a sieve (and optionally, a second filter adjacent the sieve). The pellets (or grain) are collected in the interior volume and descend downwards through the sieve (optionally shaped as frustum or frusto-conic in its lower outlet end) and are transmitted to a second pipe by way of the egress port (and the exterior port).

Optionally, the pellets (or grain) are transmitted to a second pipe by way of the egress port (and the exterior port) and pulled into a receptacle by way of a compressed air source or vacuum source.

The dust (or fine material) is collected and pulled into a storage drum by compressed air source or vacuum source.

Optionally, the dedusting system has a single vacuum source or a single compressed air source for both moving pellets (or grain) through the feed system and for the dedusting process. The compressed air source or the vacuum source is an existing source within the dedusting system as opposed to a second or separate vacuum source (or compressed air source) focused solely on dedusting the pellet (or grain). Optionally, gravity assists in the dedusting process.

The deduster has a storage volume accessible by way of the door that collects (and is suitably sized to do so) the dust and fine material. The deduster storage volume is optionally increased by way of a second storage location in a storage drum, connected by a dust collecting pipe to the storage port on the storage volume.

A deduster for receiving one or more pellets that include dust and/or fine material, comprising: an exterior body having a top surface and a bottom surface opposite the top surface, the bottom surface and the top surface joined by a side surface, the top surface, the bottom surface and the side surface form an interior; the exterior body having an upper end a lower end opposite the upper end; the deduster having a vertical axis, a horizontal axis, and a depthwise axis; the exterior body has an inlet port is located on the upper end; the exterior body has an outlet port is located on the lower end; a sieve located within the interior having a pores or perforations, the sieve having an upper inlet end and a lower outlet end opposite to the upper inlet end; the sieve having an ingress port in the upper inlet end that is co-located with the inlet port, the sieve having an egress port located in the lower outlet end that is co-located with the outlet port; the sieve has an interior volume; the sieve includes at least one bend, slope, offset or combination thereof between the ingress port and the egress port; wherein the inlet port includes at least one of a bend, slope or offset; wherein the interior has a storage volume outside of the sieve for receiving the dust and/or fine material.

A deduster wherein the sieve has a tapered shape such that the ingress port has an ingress cross-sectional area that is greater than an egress cross-sectional area of the egress port.

A deduster wherein the inlet port and the outlet port are angled with respect to each other such that there is a bend or offset therebetween.

A deduster wherein the inlet port is orthogonal to the outlet port.

A deduster wherein the exterior body of the deduster further comprises a door that is movable to enable access to the interior.

A deduster wherein the door includes or attaches to the inlet port and the ingress port.

A deduster wherein an aspect ratio of the ingress cross-sectional area of the ingress port to the egress cross-sectional area of the egress port is between about 10:1 and about 2:1.

A deduster for receiving one or more pellets that include dust and/or debris, comprising: an exterior body having a top surface and a bottom surface opposite the top surface, the bottom surface and the top surface joined by a side surface, the top surface, the bottom surface and the side surface form an interior volume; the exterior body having an upper end a lower end opposite the upper end; the deduster having a vertical axis, a horizontal axis, and a depthwise axis; the exterior body has an inlet port is located on the upper end; the exterior body has an outlet port is located on the lower end; a sieve located within the interior volume having a pores or perforations, the sieve having an upper inlet end and a lower outlet end opposite to the upper inlet end; the sieve having an ingress port in the upper inlet end that is co-located with the inlet port, the sieve having an egress port located in the lower outlet end that is co-located with the outlet port; the sieve includes at least one bend, slope, offset or combination thereof between the ingress port and the egress port; wherein the inlet port includes at least one of a bend, slope or offset; wherein the interior volume has a storage volume outside of the sieve or receiving dust and/or debris; wherein, the one or more pellets and the dust and/or fine material flow through the inlet port and into the ingress port of the sieve, travelling downwardly through the sieve; wherein, due to cyclonic movement within the deduster, the dust and/or fine material travels through the pores or perforations while the one or more pellets travel downwardly through the sieve and out the egress port and the outlet port.

A deduster wherein the sieve has a tapered shape such that the ingress port has an ingress cross-sectional area that is greater than an egress cross-sectional area of the egress port.

A deduster wherein the inlet port and the outlet port are angled with respect to each other such that there is a bend or offset therebetween.

A deduster wherein the inlet port is orthogonal to the outlet port.

A deduster wherein the exterior body of the deduster further comprises a door that is movable to enable access to the interior.

A deduster wherein the door includes or attaches to the inlet port and the ingress port.

A deduster further comprising one or both of a vacuum and a blower source.

A deduster wherein an aspect ratio of the ingress cross-sectional area of the ingress port to the egress cross-sectional area of the egress port is between about 10:1 and about 2:1.

### DESCRIPTION OF THE FIGURES

FIG. 1 is a schematic of an embodiment of the present disclosure;

FIG. 2 is a sectional view of an embodiment of the present disclosure;

FIG. 3 is a sectional view of an embodiment of the present disclosure;

FIG. 4 is an embodiment of the present disclosure;

FIG. 5 is an embodiment of the present disclosure; and

FIG. 6 is a flow diagram of an embodiment of the present disclosure;

### DETAILED DESCRIPTION OF THE PRESENT DISCLOSURE

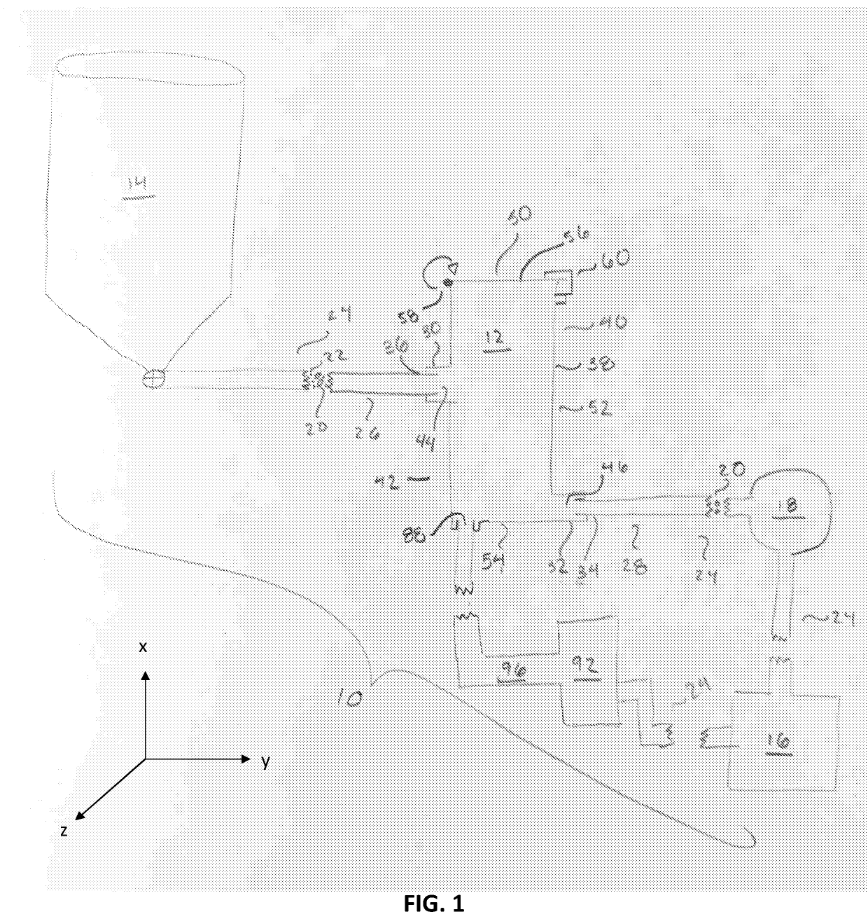

FIG. 1 generally exemplifies the present disclosure, albeit the location of various components and apparatuses of the system are movable and are only so positioned for illustrative purposes. FIG. 1 provides a dedusting system 10. The dedusting system 10 includes a silo or hopper 12 including the pellet (or grain) 20 material that needs to be dedusted. The dedusting system 10 includes a receptacle 18 where pellets (or grain) 20 are collected after going through the deduster 12. The dedusting system 10 includes a storage drum 92 where dust (or fine material) 22 is collected after going through the deduster 12. The dedusting system 10 includes a vacuum source 16 to apply pressure and cause the pellets (or grain) 10 to be evacuated from the silo or hopper 12. Optionally, a blower source forces or blows air (or compressed air) at the pellets (or grain) 20 from the silo or hopper 12 and towards the deduster 12 and through the deduster 12. In such an embodiment, the blower source is in-line with the silo and deduster, or is in advance of the silo or hopper 12, thereby pushing/blowing/forcing pellets (or grain) 20 that are descending from the hopper by way of gravity into pipe 24 and towards deduster 12. In some embodiments, a combination of blown (or forced or compressed) air, vacuum, and gravity are used to move pellets (or grain) 20 through the deduster 12 and through the dedusting system 10 in general. The vacuum source 16 is attached to a pipe 24 enabling the pellets (or grain) 20 to travel therethrough to a receptacle 18. The vacuum source 16 is attached to a pipe 24 enabling the dust (or fine material) 22 to travel therethrough to a storage drum 92. The pipe 24 includes a first pipe 26 with a first silo end 30 connected the silo or hopper 12, and a second pipe 28 having a second vacuum end 32 connect to the vacuum source 16. In between the first pipe 26 and the second pipe 28 is a dedusting apparatus (or deduster) 12. The pipe 24 includes sections that connect the vacuum source 16 and the receptacle 18 and the storage drum 92, respectively. The dedusting apparatus 12 has an exterior body 38 having an upper end 40 and a lower end 42. The deduster 12 is generally cylindrical or tubular, but other polygonal prismatic shapes (cubic, rectangular prism, etc.) are within the scope of the present disclosure.

The dedusting system 10 and deduster 12 include a vertical axis (x), a horizontal or widthwise axis (y), and a depthwise axis (z). The widthwise axis (y) and depthwise axis (z) create a lateral plane. The vertical axis (x) and the horizontal axis (y) create a vertical plane. The vertical axis (x) and depthwise axis (z) create a depthwise plane.

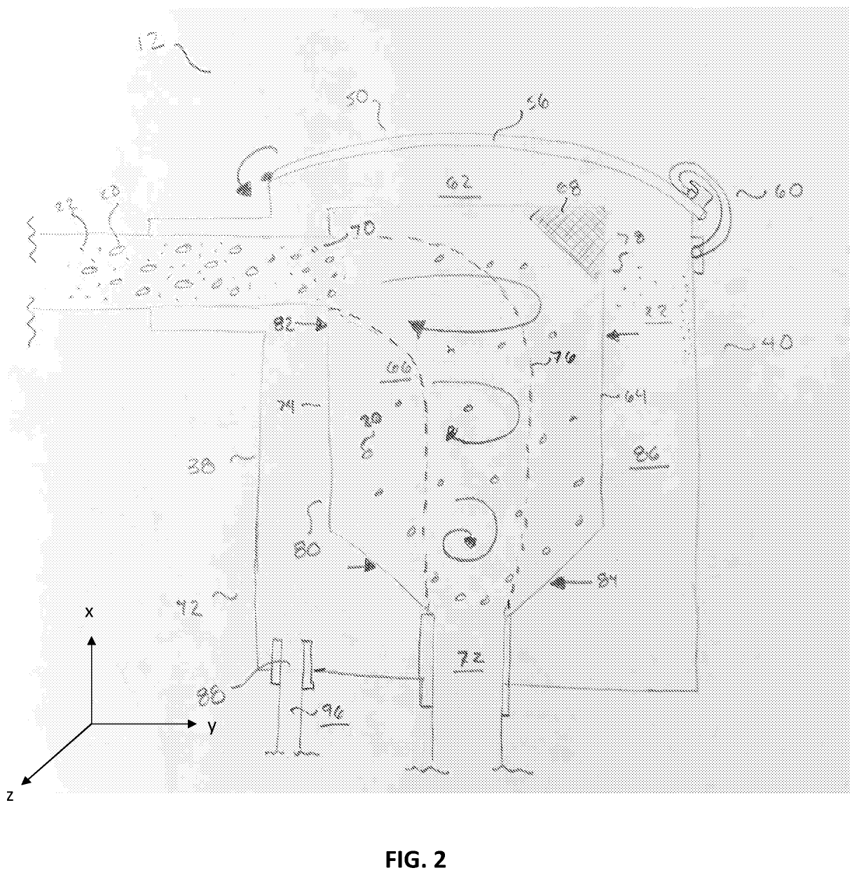

Exemplary embodiments of a sectional view of the deduster 12 are shown in FIGS. 2-5. The upper end 40 includes an inlet port 44 connecting to the second dedusting end 34 of the first pipe 26 (by way of known connecting means, such as a fitting, glue, weld, or other mechanical fastening means). The lower end 42 includes an outlet port 46 connecting to a first dedusting end 36 of the second pipe 28 (by way of known connecting means, such as a fitting, glue, weld, or other mechanical fastening means). The inlet port 44 and the outlet port 46 are configured to require a bend, slope, or offset 76 therebetween. In one embodiment, the inlet port 44 and the outlet port 46 are generally orthogonal to each other such that the inlet port 44 is on the top surface 50 of the exterior body 38 while the outlet port 46 is on the side surface 52 of the exterior body 38.

Alternatively, in another embodiment, the inlet port 44 is on the side surface 52 of the exterior body 38 and the outlet port 46 is on the bottom surface 54 of the exterior body 38.

In further embodiments and by reference of a plane defined by the horizontal axis (y) and the depthwise axis (z), the inlet port 44 is angled with respect to the sieve 64 such that the first pipe 26 or inlet port 44 has a bend of between about 90 degrees and about 165 degrees, or about 90 degrees, or about 115 degrees, or about 120 degrees, or about 130 degrees, or about 135 degrees, or about 150 degrees, or about 165 degrees.

In further embodiments and by reference of a plane defined by the horizontal axis (y) and the depthwise axis (z), the outlet port 46 is angled with respect to the sieve 64 such that the second pipe 28 or outlet port 46 has a bend of between about 90 degrees and about 165 degrees, or about 90 degrees, or about 115 degrees, or about 120 degrees, or about 130 degrees, or about 135 degrees, or about 150 degrees, or about 165 degrees.

In further embodiments, from a top view and by way of a plane created along the vertical axis (x) and the depthwise axis (z), the inlet port 44 and the outlet port 46 are angled with respect to each other by between 0 degrees and 360 degrees, or between about 15 degrees and about 345degrees, or by between about 30 degrees and about 330 degrees, or between about 45 degrees and 315 degrees, or by between about 60 degrees and about 300 degrees, or by between about 75degrees and about 285 degrees, or by between about 90 degrees and 270 degrees, or by about 15degrees, by about 30 degrees, by about 45 degrees, by about 60 degrees, by about 75 degrees, by about 90 degrees, by about 120 degrees, by about 150 degrees, by about 180 degrees, by about 210degrees, by about 240 degrees, by about 270 degrees, by about 300 degrees, by about 330 degrees.

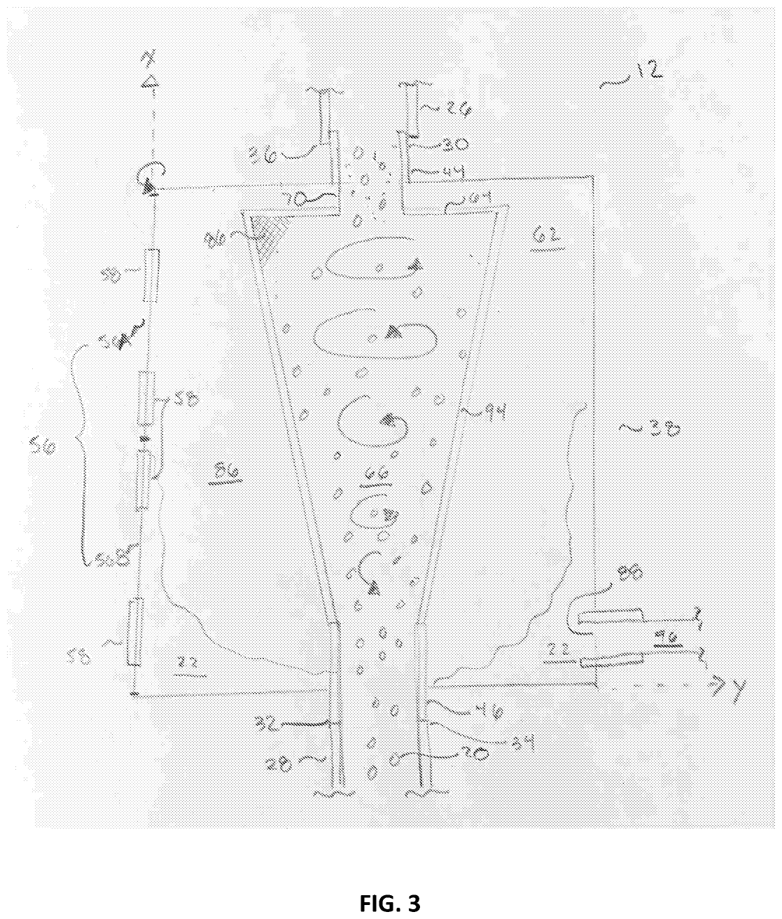

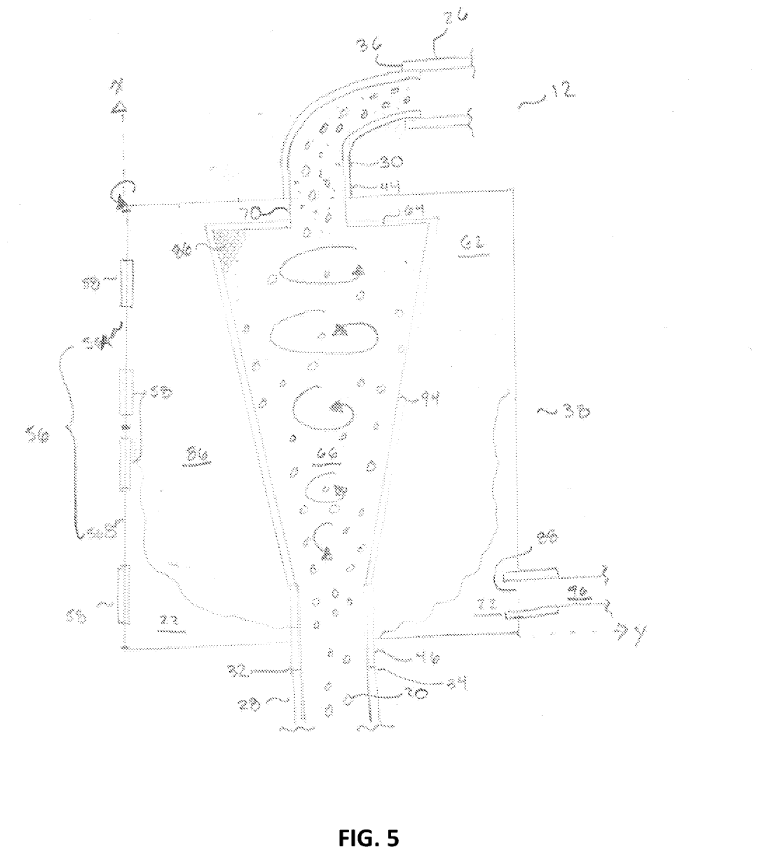

The dedusting apparatus 12 has a door 56 movable by way of a hinge 58 to enable access to the interior 62 of the dedusting apparatus 12 by means other than the inlet port 44 and the outlet port 46 (which could be removably connected to the first pipe 26 and second pipe 28, respectively). Optionally, as in exemplary FIG. 5, the door 56 is attached to the upper end 40 such that it includes or attaches to the inlet port 44. Optionally, the door 56 is attached to the upper end 40 such that it includes or attaches to the ingress port 70 of the sieve 64. The door 56 is secured by a latch 60 to the deduster 12 such that a fully closed state can be achieved. The door 56 is attached to the upper end 40 and optionally on the top surface 50 of the deduster's 12 exterior body 38. The door 56 is optionally attached to the side surface 52 of the exterior body 38, or on the bottom surface 54 of the deduster's 12 exterior body 38. Door 56 can be any suitable type of door such as plastic flaps, or a plastic slit opening (not shown). Door 56 optionally comes with a gasket to mitigate against dust escaping the deduster 12. Optionally, as shown in exemplary FIG. 3, the door 56 is a Dutch door having upper door 56A and lower door 56B, each hingedly connected via hinges 58 to the exterior body 38. The Dutch door 56 includes a lip on each of upper door 56A and lower door 56B configured to mate thereby enabling the door 56 to seat properly and operate as a single door. A latch 60 (not shown in FIG. 3) holds the upper door 56A to lower door 56B. A latch 60 (not shown in FIG. 3) holds door 56 to exterior body 38 in a closed condition. Latch 60 includes other mechanical fasteners or other mechanical means of assisting in closing door 56 (or upper door 56A and lower door 56B). Dutch door 56 enables partial access while mitigating against dust (or fine material) 22 from escaping from the storage volume 86 until the storage volume 86 can be cleared away from lower door 56B. Alternatively, lower door 56B can be opened to enable dust (or fine material) 22 to be released in a controlled manner and to mitigate against dust being kicked-up and outward.

Within the deduster apparatus 12 is a sieve, screen, or filter 64. The sieve, screen, or filter 64 encompasses and provides a channel (or interior volume) 66 for the pellets (or grain) 20 to flow from the inlet port 44 to the exit port 46. The sieve 64 includes a porosity or perforations such that dust and other fine materials 22 can escape from the sieve 64 through one or more pores (or perforations) 68 therein while the pellet (or grain) 20 is contained within the sieve 64 as it has a size that exceeds the dimensions of one or more pores (or perforations) 68 within the sieve 64. Pores (or perforations) are shown by hatched portions on FIGS. 2 and 3, and while not shown along the entirety of the sieve 64, such configuration is within the scope of the present disclosure.

The sieve 64 can be generally tubular, but other polygonal prismatic shapes (cubic, rectangular prism, etc.) are within the scope of the present. The sieve 64 has an ingress port 70 co-located with the inlet port 44 on the exterior body 38. The sieve 64 has an egress port 72 co-located with the outlet port 46 on the exterior body 38. The ingress port 70 and egress port 72 are angled with respect to each other such that at least some of the pellets (or grain) 20 are, by way of vacuum applied to the deduster 12 (and the dedusting system 10) flow into and thus are deflected off of the sieve body 74. Optionally, the ingress port 70 and the egress port 72 are generally orthogonal.

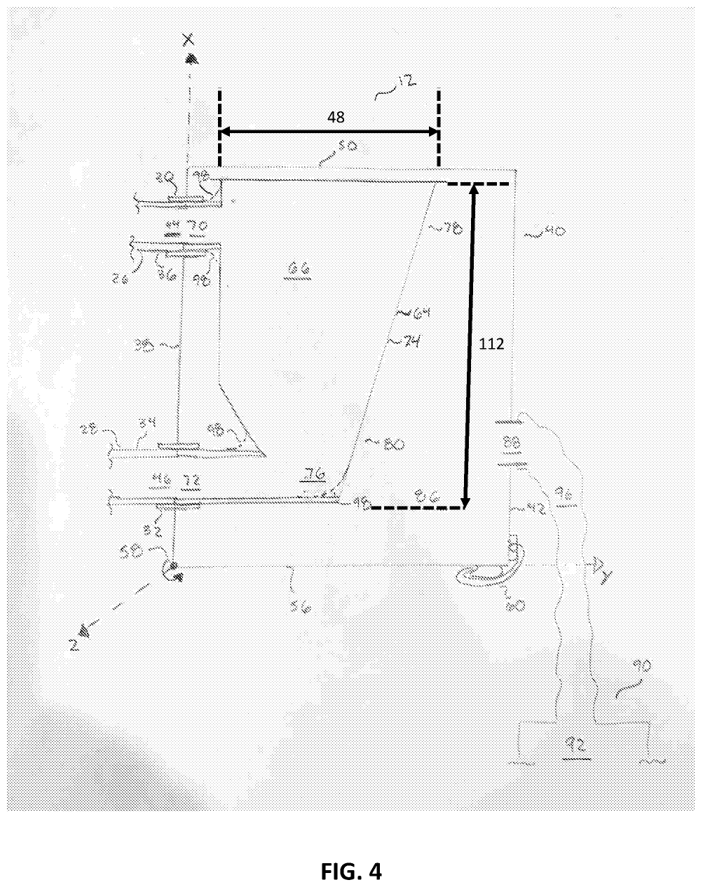

The sieve 64 optionally has at least one bend, slope, or offset, or combination thereof (each shown as 76). Optionally, as shown by dashed lines in FIG. 4, fillet or roundel (each shown as 98) adds further curvature to direct pellets (or grain) 20 out of ingress port 70, through sieve, and/or into egress port 72. In one embodiment, the sieve 64 has a substantially right-angle bend 76 between the sieve's 64 upper inlet end 78 and the sieve's 64 lower outlet end 80. In one embodiment, the diameter (or width and depth, depending on the cross-sectional shape of the sieve) is generally larger proximal the upper inlet end 78 and is generally narrower proximate the lower outlet end 80, and as such, the cross-sectional area of the sieve 64 proximal the upper inlet end 78 is larger than the cross-sectional area of the sieve 64 proximal the lower inlet end 80. The ingress port 70 has an ingress cross-sectional area that is greater than the egress cross-sectional area of the egress port 72. The sieve 64 has a tapered, sloping or narrowing shape.

The upper inlet end 78 is optionally generally cylindrical. Optionally, there is a bend or offset 76 between the upper inlet end 78 and the lower outlet end 80. The lower outlet end 80 is optionally tapered, sloping, or a frustum (frusto-conical) thereby facilitating flow of pellets (or grain) 20 into the outlet port 46 and the second pipe 28.

The present disclosure makes use of an existing vacuum source 16 applied to the dedusting system 10. As pellets (or grain) 20 are drawn into the deduster 12, centrifugal or cyclonic forces draw the pellets (or grain) 20 around the interior volume 66 of the sieve 64 thereby forcing dust (and fine material) 22 through the sieve 64 and out of the interior volume 66 of the sieve 64. The dust (and fine material) 22 through the sieve 64 outward from the interior volume 66 and into the storage volume 86. The pellets (or grain) 20, by way of such cyclonic movement (and optionally, vacuum and/or gravity), descend downward to the outlet port 46 (and the lower outlet port 80) and into the second pipe 28.

The upper inlet end 78 has an upper inlet diameter (or depth and/or width) 82. The lower outlet end 80 has a lower outlet diameter (or depth and/or width) 84. The upper inlet diameter (or depth and/or width) 82 is larger than the lower outlet diameter (or depth and/or width) 84.

In some embodiments, the ingress port 70 and the egress port 72 are the same diameter (or depthwise and widthwise dimensions). In some embodiments, the ingress port 70 has a smaller diameter (or depthwise and widthwise dimensions) than the egress port 72. In some embodiments, the ingress port 70 has a larger diameter (or depthwise and widthwise dimensions) than the egress port 72.

By way of non-limiting example, the dimensions of the deduster 12 are relatively small with regard to vacuum feed pellet (or grain) systems. For instance, the ingress port 70 is between about 2 inches and about 10 inches or between about 2 inches and about 8 inches, or between about 2 inches and about 3 inches, or between about 5 inches and about 8 inches, or between about 7 inches and about 8 inches, and the egress port 70 is also between about 2 and about 10 inches, or between about 2 inches and about 8 inches, or between about 2 inches and about 3 inches, or between about 5 inches and about 8 inches, or between about 6 inches and about 8 inches. The length of the ingress port 70 and egress port 72 is about 2 inches to about 5 inches, or about 2 inches to about 3 inches. Similar dimensions exist for the inlet port 44 and the outlet port 46, as well as the first pipe 26, and second pipe 28, such that all of these components matingly engage (respectively) as taught by the present disclosure. The sieve 64 has a height 112 of about 10 inches to about 24 inches, or about 10 inches to about 15 inches, or about 12 inches, and a width 48 of about five inches to about 12 inches, or about 6 inches to about 8 inches, or about 7 inches. An aspect ratio of the inlet cross-sectional area of the inlet port 44 to the outlet cross-sectional area of the outlet port is between about 1:2 and about 2:1. An aspect ratio of the ingress cross-sectional area of the ingress port 70 to the egress cross-sectional area of the egress port 72 is between about 10:1 and about 2:1, or between about 8:1 and about 3:1, or between about 8:1 and about 5:1, or is about 10:1, or is about 9:1, or is about 8:1, or is about 5:1, or is about 3:1, or is about 2:1. The dimensions are exemplary and one skilled in the art understands these dimensions and the scope of the present disclosure as scalable to larger and smaller embodiments to accommodate a variety of sized vacuum feeding systems involving pellets (or grain) 20.

An advantage of the present disclosure is that the deduster apparatus 12 is relatively small and in-line with existing piping 24 for the entire system (or vacuum feed system). Such design reduces the amount of manufacturing floor space required. Said differently, no additional floor space is required as the deduster 12 can be installed on an existing section of piping 24. Furthermore, the deduster apparatus 12 does not require an additional energy source, or an additional force or pressure generated separately from the energy, force and/or pressure that already exists within the pellet (or grain) 12 feeding system. This delivers cost savings in both energy usage and also in the need for additional expensive equipment, replacement parts, etc., and is thus preferable from an environmental perspective.

The exterior body 38 and the sieve 64 are separated by a storage volume 86. The storage volume 86 is suitably sized to accommodate dust and fine material 22 that has been removed from the pellets (or grain) 20 by way of the sieve 64. The size of the storage volume 86 can be modified to enable clean-out at a particular frequency (i.e., daily, weekly, etc.). The size of the storage volume 86 accommodates simple wipe-out and removal of the contents by way of the door 56. If desired, the storage volume 86 connects by way of a storage port 88 to a separate dust storage location 90 such as a drum 92 to enable collection of larger volumes of dust (and fine material) 22 to reduce the frequency of clean-out. Such separate dust storage configuration can include a pipe 94 connecting the storage port 88 and the storage drum 92.

Optionally, as shown in exemplary FIG. 3, a second filter 94 can be applied to the sieve 64 to further collect dust (or fine material).

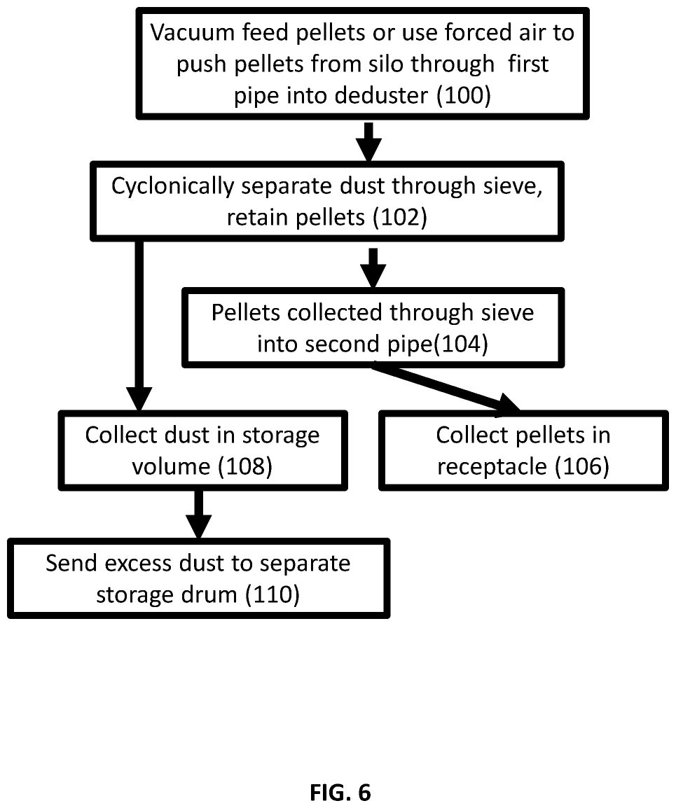

A process or method of separating pellets (or grain) 20 from dust is provided, as outlined in FIG. 6, including the steps of: vacuum feeding pellets (or grain) 20 having dust and/or fine material 22 into a deduster 12i through a first pipe 26 into the inlet port 44 on the exterior body 38 of the deduster 12 and through the ingress port 70 of the sieve (100); the pellets (or grain) 20 undergoing a cyclonic movement by contacting the sieve 74 causing dust and/or fine material 22 to shake loose of the pellets (or grain) 20 and travel through the one or more pores 68 of the sieve (102); moving by way of the cyclonic movement (and optionally drawing by way of the vacuum and/or gravity) the pellets (or grain) 20 downward through the interior volume 66 of the sieve 64 and out the egress port 72 (and outlet port 46) and into a second pipe and into receptacle 18 (104); collecting the pellets (or grain) 20 into a receptacle 18 by way of the second pipe (106); collecting the dust or fine material 22 in the storage volume 86 of the deduster (108). An optional step includes sending dust or fine material 22 from storage volume 86 through storage port 88 to a separate storage location 90 to a storage drum 92 by way of dust collecting pipe 96 (110). The process or method as described utilizes the deduster system 10 as described in greater detail throughout the present disclosure. Optionally, in addition to or instead of using a vacuum feed, forced air (such as compressed air or other fluids) are used to feed pellets (or grain) 20 having dust and/or fine material 22 into a deduster 12.

Suitable materials for the exterior wall include sheet metal, stainless steel, plastics, laminate materials, fabric, wood, combinations thereof, etc. Suitable materials for the sieve include screen material, filter material, stainless steel, combinations thereof, etc. The first pipe and second pipe can be plastic (i.e., schedule 40, pex, etc.), flexible tubing, carbon fiber, terra cotta, ceramic, glass, or metal such as copper, stainless steel, aluminum, iron, etc.

In this document, the terms “a” or “an” are used, as is common in patent documents, to include one or more than one. In this document, the term “or” is used to refer to a nonexclusive or, unless otherwise indicated. It is to be understood that the above description is intended to be illustrative, and not restrictive. For example, the above-described embodiments (and/or aspects thereof) may be used in combination with each other. Many other embodiments will be apparent to those of skill in the art upon reviewing the above description. For instance, the inlet port and outlet port could be swapped (and likewise the ingress port and egress port) such that the outlet port is on the top surface or the upper side surface of the exterior body. Similarly, the inlet port and outlet port (and likewise the ingress port and egress port) can also be lateral and lie in the same horizontal plane as opposed to occupying a similar vertical plane. The scope of the present disclosure should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc., as they may be included, are used merely as labels, and are not intended to impose numerical requirements on their objects. In the Detailed Description provided above, various features may be grouped together to streamline the disclosure. This method of disclosure is not to be interpreted as reflecting an intention that the claimed embodiments require more features than are expressly recited in each claim. Rather, as the following claims reflect, inventive subject matter may lie in less than all features of a single disclosed embodiment. Thus, the following claims are hereby incorporated into the Detailed Description, with each claim standing on its own as a separate embodiment.

1. A deduster for receiving one or more pellets that include dust and/or fine material, comprising:
an exterior body having a top surface and a bottom surface opposite the top surface, the bottom surface and the top surface joined by a side surface, the top surface, the bottom surface and the side surface form an interior; the exterior body having an upper end a lower end opposite the upper end; the deduster (12)-having a vertical axis (x), a horizontal axis (y), and a depthwise axis (z); the exterior body has an inlet port is located on the upper end; the exterior body has an outlet port is located on the lower end;
a sieve located within the interior having a pores or perforations, the sieve having an upper inlet end and a lower outlet end opposite to the upper inlet end; the sieve having an ingress port in the upper inlet end that is co-located with the inlet port, the sieve having an egress port located in the lower outlet end that is co-located with the outlet port; the sieve has an interior volume; the sieve includes at least one bend, slope, offset or combination thereof between the ingress port and the egress port;
wherein the inlet port includes at least one of a bend, slope or offset;
wherein the interior has a storage volume outside of the sieve for receiving the dust and/or fine material.

2. A deduster according to claim 1, wherein the sieve has a tapered shape such that the ingress port has an ingress cross-sectional area that is greater than an egress cross-sectional area of the egress port.

3. A deduster according to claim 1, wherein the inlet port and the outlet port are angled with respect to each other such that there is a bend or offset therebetween.

4. A deduster according to claim 1, wherein the inlet port is orthogonal to the outlet port.

5. A deduster according to claim 1, wherein the exterior body of the deduster further comprises a door that is movable to enable access to the interior.

6. A deduster according to claim 5, wherein the door includes or attaches to the inlet port and the ingress port.

7. A deduster according to claim 1, wherein an aspect ratio of the ingress cross-sectional area of the ingress port to the egress cross-sectional area of the egress port is between about 10:1 and about 2:1.

8. A deduster for receiving one or more pellets that include dust and/or debris, comprising:
an exterior body having a top surface and a bottom surface opposite the top surface, the bottom surface and the top surface joined by a side surface, the top surface, the bottom surface and the side surface form an interior volume; the exterior body having an upper end a lower end opposite the upper end; the deduster having a vertical axis (x), a horizontal axis (y), and a depthwise axis (z); the exterior body has an inlet port is located on the upper end; the exterior body has an outlet port is located on the lower end;
a sieve located within the interior volume having a pores or perforations, the sieve having an upper inlet end and a lower outlet end opposite to the upper inlet end; the sieve having an ingress port in the upper inlet end that is co-located with the inlet port, the sieve having an egress port located in the lower outlet end that is co-located with the outlet port; the sieve includes at least one bend, slope, offset or combination thereof between the ingress port and the egress port;
wherein the inlet port includes at least one of a bend, slope or offset;
wherein the interior volume has a storage volume outside of the sieve for receiving dust and/or debris;
wherein, the one or more pellets and the dust and/or fine material flow through the inlet port and into the ingress port of the sieve, travelling downwardly through the sieve;
wherein, due to cyclonic movement within the deduster, the dust and/or fine material travels through the pores or perforations while the one or more pellets travel downwardly through the sieve and out the egress port and the outlet port.

9. A deduster according to claim 8, wherein the sieve has a tapered shape such that the ingress port has an ingress cross-sectional area that is greater than an egress cross-sectional area of the egress port.

10. A deduster according to claim 8, wherein the inlet port and the outlet port are angled with respect to each other such that there is a bend or offset therebetween.

11. A deduster according to claim 8, wherein the inlet port is orthogonal to the outlet port.

12. A deduster according to claim 8, wherein the exterior body of the deduster further comprises a door that is movable to enable access to the interior.

13. A deduster according to claim 12, wherein the door includes or attaches to the inlet port and the ingress port.

14. A deduster according to claim 8, further comprising one or both of a vacuum and a blower source.

15. A deduster according to claim 8, wherein an aspect ratio of the ingress cross-sectional area of the ingress port to the egress cross-sectional area of the egress port is between about 10:1 and about 2:1.

16-30. (canceled)
